(19) United States
(12) Patent Application Publication
(10) Pub. No.: US 2011/0291904 A1
(43) Pub. Date: Dec. 1, 2011

(54) Extended magnetic core antenna

(76) Inventors: Gareth Conway, Keady (GB); Brendan Peter Hyland, Edinburgh (GB)

(21) Appl. No.: 12/787,499

(22) Filed: May 26, 2010

(51) Int. Cl. H01Q 7/08

(52) U.S. Cl. 343/788

(57) ABSTRACT

The present invention discloses an antenna for coupling to a magnetic field component of an electromagnetic signal. The antenna comprises a coil of wire 121 having a pair of terminals 122 formed over an extended core 130 of a material having a relative magnetic permeability (μ_{R}) greater than unity. The extended core 130 comprises an elongate portion 135 having a long dimension along a first (Z) axis and short dimensions in a (X, Y) plane perpendicular to the first axis, and comprises first and second ends 133, 134 at opposite extremities of the long dimension. The extended core 130 further comprises at least one flange portion, 136, 137, disposed at one of the first and said second ends 133, 134 of the elongate section 135, having at least one larger dimension than the elongate section in the (X, Y) perpendicular plane. The extended core 130 of the antenna of the present invention has an increased effective magnetic permeability compared with a core absent the at least one flange portion 136, 137 thereby providing an antenna having an increased efficiency compared with an antenna absent the at least one flange portion.

### FIELD OF USE

The present invention relates to the field of magnetically coupled antennas for wireless communications by electromagnetic signaling.

### Description of the Related Art

Magnetically coupled antennas for transmitting and receiving low-frequency signals are well known in the art of radio design. In particular, magnetically coupled antennas are commonly used for receiving low-frequency radio signals. For example, radio signals which are encoded on a long or medium wavelength carrier signal by means of amplitude modulation (AM) are commonly received on domestic portable radio units via a magnetic loop antenna wound on a ferrite core.

U.S. Pat. No. 6,529,169; “Twin coil antenna”; Christopher M. Justice teaches such a magnetically coupled receiver antenna. The antenna taught by Justice is suitable for receiving long wave or medium wave radio signals and comprises a ferrite core antenna having two spaced-apart signal pick-up coils, where the signals from the two coils are additively combined in the primary windings of a transformer. U.S. Pat. No. 6,163,305 “Loop Antenna Device”; Yuichi Murakami et al teaches a similar antenna with perpendicularly disposed receive coils.

U.S. Pat. No. 3,987,448; “AM/FM antenna system”; Ronald K. Scheppman, teaches an antenna system for a conventional AM/FM radio having a ferrite rod antenna for receiving AM radio a telescopic whip antenna for receiving FM radio and an input for a separate antenna. The antenna system taught by Scheppman may be integrated inside an enclosure, such as a housing for an AM/FM radio. U.S. Pat. No. 2,740,114; “ROD ANTENNA”; Adams, teaches another ferrite rod antenna, which is incorporated inside an enclosure.

Magnetic loop antennas for receiving low frequency electromagnetic signals, such as those taught in the prior art, are fundamentally low in efficiency.

In many applications, the low efficiency of prior art ferrite rod and other magnetic core antennas is not a significant problem. For example, long wavelength and medium wavelength radio signals are transmitted at very high power levels so that there is typically a high field intensity of the signal when received. Nonetheless, there are applications requiring high efficiency antennas for transmitting and receiving low frequency electromagnetic signals; prior art ferrite rod antennas present significant limitations for such applications.

### SUMMARY OF THE INVENTION

An object of the present invention is to provide an antenna for coupling to a magnetic field component of an electromagnetic signal having an extended core of material having a high magnetic permeability which provides increased sensitivity of the antenna compared with a conventional rod antenna.

A further object of the present invention is to provide an antenna for coupling to a magnetic field component of an electromagnetic signal having an extended core where the extended core does not result in a substantial increase in the volume occupied by the antenna compared with a conventional rod antenna.

Accordingly, the present invention provides an antenna for coupling to a magnetic field component of an electromagnetic signal. The antenna of the present invention comprises a coil of wire having a pair of terminals formed over an extended core of a material having a having a relative magnetic permeability (μ_{R}) greater than unity. The extended core comprises an elongate portion having a long dimension along a first (Z) axis and short dimensions in a (X, Y) plane perpendicular to the first axis, and comprises first and second ends at opposite extremities of the long dimension. The extended core further comprises at least one flange portion, disposed at one of the first and said second ends of the elongate section, and having at least one larger dimension than the elongate section in the (X, Y) perpendicular plane. The extended magnetic core of the antenna of the present invention has an increased effective magnetic permeability compared with a core absent the at least one flange portion thereby providing an antenna having an increased efficiency compared with an antenna absent the at least one flange portion.

Embodiments of the present invention will now be described in detail with reference to the accompanying figures in which:

### BRIEF DESCRIPTION OF DRAWINGS

FIG. 1 shows an extended magnetic core antenna according to a first embodiment of the present invention.

FIG. 2 shows a plot of the magnetic flux density induced inside a cylindrical magnetic core.

FIG. 3A shows a plot of the magnetic flux density induced inside a magnetic core having flanges at opposing ends thereof.

FIG. 3B shows a plot of the magnetic flux density induced inside a magnetic core having very large flanges at opposing ends thereof.

FIG. 4 shows a plot of the magnetic flux density induced inside the magnetic cores of FIG. 2, FIG. 3A and FIG. 3B plotted on the same axes.

FIG. 5 shows an extended magnetic core antenna housed inside an enclosure according to a second embodiment of the present invention.

### DETAILED DESCRIPTION

The present invention provides an extended magnetic core antenna for coupling to a magnetic field component of an electromagnetic signal, said antenna comprising a coil formed over an extended core of a material having a relative magnetic permeability (μ_{R}) greater than unity; said extended core comprising an elongate portion having a long dimension along a first (Z) axis and short dimensions in a (X, Y) plane perpendicular to said first axis, and comprising first and second ends at opposite extremities of said long dimension, said coil being wound around said elongate portion; said extended core further comprising at least one flange portion disposed at one of said first and said second ends, and having at least one larger dimension than said elongate section in said (X, Y) perpendicular plane, wherein said extended core has an increased effective magnetic permeability compared with a core absent said at least one flange portion.

Advantageously, said extended core provides an antenna having an increased sensitivity for receiving said electromagnetic signal compared with an antenna comprising a core absent said at least one flange portion.

Advantageously, said extended core provides an antenna having an increased efficiency for transmitting said electromagnetic signal compared with an antenna comprising a core absent said at least one flange portion.

In some embodiments, said coil is wound around said elongate section. Said coil may further comprise a pair of terminals, wherein said extended core provides an increased induced voltage by said electromagnetic signal at said pair of terminals compared with an antenna comprising a core absent said at least one flange portion.

Advantageously, said at least one flange portion is in contact with said elongate section at one of said first and said second ends.

Preferably, said long (Z) dimension of said elongate portion of said core is at least five times greater than each said short (X, Y) dimension thereof.

In some embodiments, said antenna is a receive antenna.

In some embodiments, the material of said extended core is ferrite; alternatively, said extended core is formed of a material preferably having a relative magnetic permeability (μ_{R}) greater than 10.

In some embodiments, said coil is formed of electrically conductive wire having an electrically insulating covering.

In one embodiment, said flange portion extends away from said elongate portion in at least one direction in said (X, Y) perpendicular plane.

In another embodiment, said antenna comprises first and second flange portions respectively disposed at said first and second ends of said elongate portion of said extended core.

In yet another embodiment, a cross section of said elongate section of said extended core in said perpendicular (X, Y) plane is circular.

Preferably, the antenna of the present invention couples to an electromagnetic signal having a frequency in the range from 1 Hz to 100 MHz.

In one embodiment, said extended magnetic core antenna, further comprises a housing wherein said at least one flange portion is flush with a wall of said housing. Said at least one flange portion may alternatively be formed inside a wall of said housing.

In another embodiment, the present invention provides a receiver for receiving an electromagnetic signal comprising an extended magnetic core antenna for coupling to a magnetic field component of said electromagnetic signal, said antenna comprising a coil formed over an extended core of a material having a relative magnetic permeability (μ_{R}) greater than unity; said extended core comprising an elongate portion having a long dimension along a first (Z) axis and short dimensions in a (X, Y) plane perpendicular to said first axis, and comprising first and second ends at opposite extremities of said long dimension, said coil being wound around said elongate portion; said extended core further comprising at least one flange portion disposed at one of said first and said second ends, and having at least one larger dimension than said elongate section in said (X, Y) perpendicular plane, wherein said extended core has an increased effective magnetic permeability compared with a core absent said at least one flange portion.

In another embodiment, the present invention provides a system for communications through the earth or through the water by electromagnetic signals comprising an extended magnetic core antenna for coupling to a magnetic field component of said electromagnetic signals, said antenna comprising a coil formed over an extended core of a material having a relative magnetic permeability (μ_{R}) greater than unity; said extended core comprising an elongate portion having a long dimension along a first (Z) axis and short dimensions in a (X, Y) plane perpendicular to said first axis, and comprising first and second ends at opposite extremities of said long dimension, said coil being wound around said elongate portion; said extended core further comprising at least one flange portion disposed at one of said first and said second ends, and having at least one larger dimension than said elongate section in said (X, Y) perpendicular plane, wherein said extended core has an increased effective magnetic permeability compared with a core absent said at least one flange portion.

Magnetically coupled antennas comprising a coil of wire or a solenoid having multiple windings wound around a rod or core having a high relative magnetic permeability μ_{R} can be used to receive and detect the magnetic component of low frequency electromagnetic signals. A magnetic component of an electromagnetic signal, which is incident on the core of such an antenna, and where the direction of the magnetic field is parallel to the axis of the core induces an electromotive force (emf) in the coil of wire wound over the core. The signal can be detected at a pair of terminals of the coil of wire.

The magnitude of an induced signal in a magnetic core antenna is given by the following equation.

emf=nAωμ_{E}μ₀H₀ Equation 1

where
μ_{E}=effective magnetic permeability of core,
μ₀=magnetic permeability of free space (4π×10⁻⁷Am⁻¹),
ω=angular frequency,
n=number of windings of solenoid,
A=Cross sectional area of magnetic core,
H₀=Magnetic field strength of incident electromagnetic signal in the absence of the core.

A given input signal has a given angular frequency w and produces a given magnetic field strength H₀ at the antenna. The sensitivity of the antenna is determined by the variables independent of the input signal in equation 1; i.e: the number of windings of the coil, n, the area of the magnetic core, A, the effective permeability μ_{E} of the core.

The number of windings of the coil can be increased to increase the antenna sensitivity; however, increasing the number of windings also increases resistive losses of the coil. There is generally a maximum value for the number of windings of the coil; this maximum value is determined by trading off of the benefit of increased sensitivity of the antenna, against the drawback of increased resistive losses. Factors which determine the maximum value of the number of windings in an antenna coil are: the cross-section area of the wire of the coil, the area of the core around which the coil is formed, and the resulting resistance of the coil wire.

Increasing the area A of the magnetic core also increases the sensitivity of the antenna; however, the area of the magnetic core is limited by the space available for the antenna in its particular application. Most applications allocate a given volume for the antenna, and the antenna designer cannot exceed the boundaries of the allocated volume.

Increasing the relative magnetic permeability μ_{R} of the material of the core also increases the sensitivity of the antenna, but again this parameter is limited by the materials available, their cost and mechanical strength etc.

Thus, the main property available to increase the sensitivity of a magnetically coupled antenna is the effective permeability of the core μ_{E}. Increasing this parameter increases the efficiency of the antenna without the detrimental effects which arise from increasing the other parameters.

An alternative expression for the induced emf in a coil of wire or a solenoid formed over a magnetic core is given by equation 2.

emf=nAωB_{AV} Equation 2

where
B_{AV}=is the average magnetic flux density inside the core.

Equations 1 and 2 provide a means to calculate the efficiency of a magnetically coupled antenna.

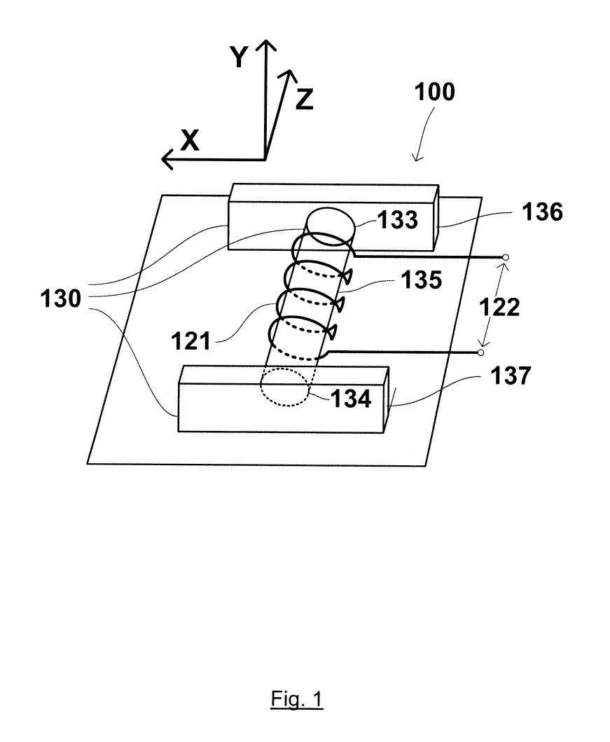

FIG. 1 shows an extended core magnetically coupled antenna 100 according to a first embodiment of the present invention. The extended magnetic core antenna 100 of FIG. 1 comprises a coil 121 wound over a magnetic core 130 formed of a material having a relative magnetic permeability μ_{R} greater than unity. A material having a relative magnetic permeability of greater than 10 is particularly suitable for magnetic core 130; though materials having relative magnetic permeabilities of greater than 100 are available. Coil 121 is formed of an electrically conductive wire having an electrically insulating coating and comprises input/output terminals 122. An output device (not shown) receiving output signals of antenna 100 may be connected to terminals 122. Alternatively an input device (not shown) may be connected across terminals 122. Magnetic core 130 comprises three separate portions: elongate portion 135, first flange portion 136 and second flange portion 137. Elongate portion 135 is substantially cylindrically shaped and is oriented so that it has a long dimension in a Z direction, and short dimensions in X and Y directions—corresponding orthogonal co-ordinate axes, X, Y and Z are shown in FIG. 1. First flange portion 136 is disposed at a first end 133 of elongate portion 135; and second flange portion 137 is disposed at a second end 134 of elongate portion 135. First flange portion 136 is rectangular in shape, and has a long dimension in the X direction, and a short dimension in the Z dimension. Second flange portion 137 is also rectangular in shape and has a long dimension in the X direction, and a short dimension in the Z dimension.

The arrangement of the magnetic core 130 of the embodiment of the present invention depicted in FIG. 1 comprising elongate portion 135 with first flange portion 136 disposed at a first end thereof and second flange portion 137 disposed at a second end thereof concentrates an incident magnetic field strongly inside elongate portion 135.

First flange portion 136 and second flange portion 137 are connected directly to elongate portion 135. This arrangement provides a low reluctance path through the magnetic core, to improve the concentration of an incident magnetic field inside elongate portion 135. Nonetheless, alternative embodiments of the present invention may comprise a magnetic core comprising an elongate portion with respective first and second flange portions disposed at respective first and second ends thereof where there is some gap between the elongate portions and the first and second flange portions.

Provided the gap is relatively small, this arrangement still provides concentration of an incident magnetic field inside the elongate portion of the magnetic core.

In the embodiment of the extended core magnetically coupled antenna of FIG. 1, elongate portion 135 is cylindrically shaped. However, any elongate shape may be used to achieve the effects of the present invention.

Similarly, first and second flange portions 136, 137 are rectangular in shape having short dimensions in the Z direction. However, the benefits of the present invention can be realized by a range of alternative shapes of first and second flange portions.

Possible dimensions of extended core 130 are provided as follows: elongate core 135—cylindrical in shape, having a diameter of 20 mm and a length of 100 mm; first and second flange portions 136, 137, disc shaped, having a diameter of 50 mm and a thickness of 5 mm.

Nonetheless, the benefits of the present invention can be realized through a range of alternative dimensions of extended magnetic core 130. To achieve the benefits of the present invention, the preferred requirements are that elongate portion has an axial dimension which is longer than its other two dimensions; that the first and second flange portions 136, 137 should extend perpendicular to the axis of the elongate portion, and that the first and second flange portions should have dimensions along the axis of elongate portion 135 which are short compared with the corresponding dimension of the elongate portion 135.

The system of the present invention shown in FIG. 1 is particularly suited to communications and/ or data transfer by electromagnetic signals having a frequency in the range from 10 Hz to 100 MHz.

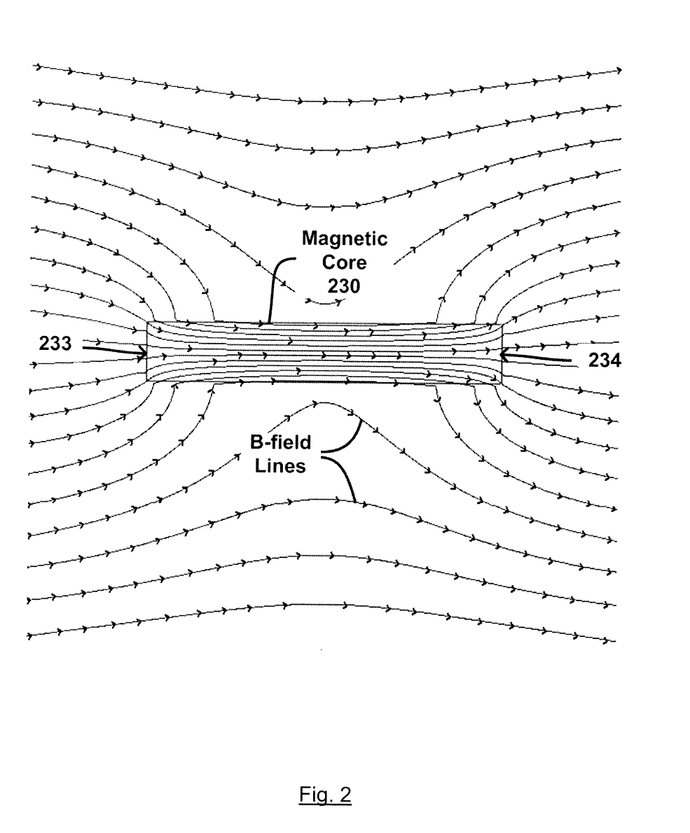

FIG. 2 shows a plot of the simulated magnetic flux density induced inside a cylindrical magnetic core 230 formed of a material having a relative magnetic permeability, μ_{R}, of 100, For the simulations of FIG. 2, an external magnetic field of 1 Tesla was applied so that the results are normalized. Cylindrical magnetic core 230 was constructed to have a length of 60 mm and a diameter of 10 mm for the simulated results of FIG. 2.

The density of magnetic field lines in the plot of FIG. 2 is higher in areas where the magnetic flux density, or B-field, is high. Correspondingly, the density of magnetic field lines in the plot of FIG. 2 is lower in areas where the magnetic flux density, or B-field, is low.

At the centre of the cylindrical magnetic core 230, the magnetic flux density—or B-field—is high. However, the magnetic flux density falls off at each end 233, 234 of the core 230.

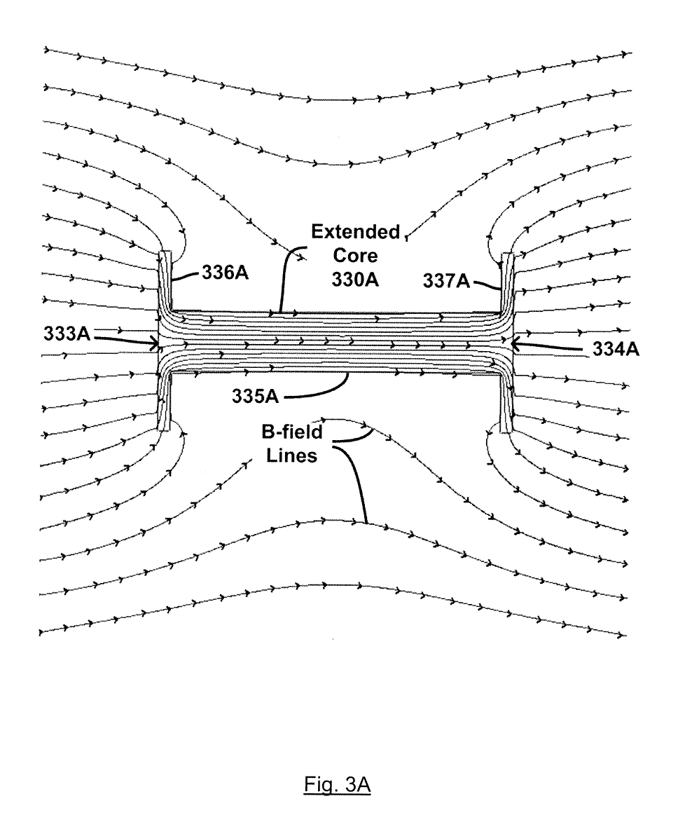

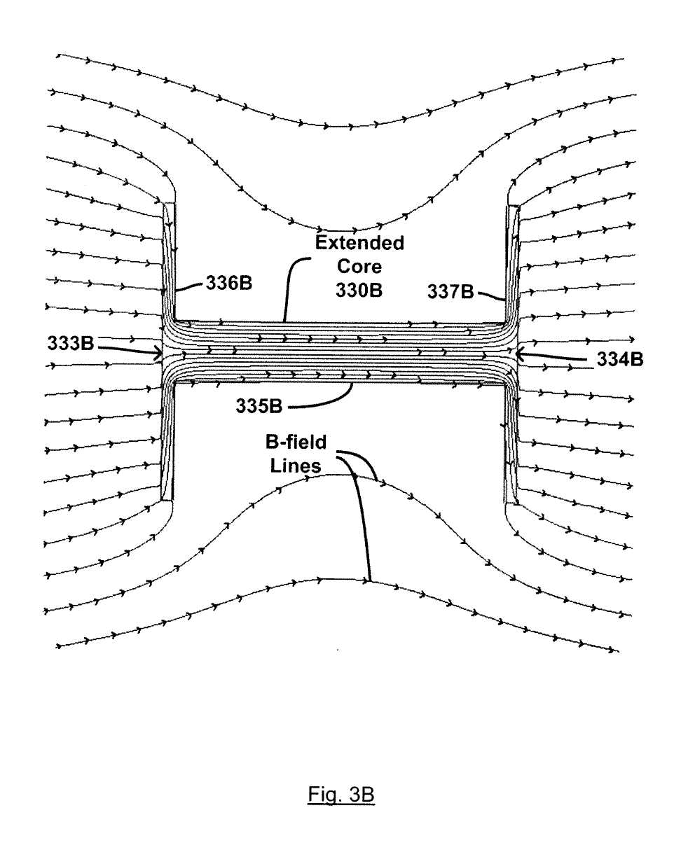

FIG. 3A shows a plot of the simulated magnetic flux density induced inside an extended magnetic core 330A having a central elongate portion 335A and respective first and second extension 336A, 337A located at a respective first 333A and second end 334A of elongate portion 335A. For the simulations of FIG. 3A, the relative permeability, μ_{R}, of the material of magnetic core 330A was set to 100 and an external magnetic field of 1 Tesla was applied so that the results are normalized. The extended magnetic core 330A was constructed so as to have an elongate portion 335A having a length of 60 mm and a diameter of 10 mm, and with first and second extensions 336A, 337A each having diameters of 30 mm.

At the centre of elongate portion 335A of magnetic core 330A, the magnetic flux density—or B-field is high. The magnetic flux density maintains a high value substantially along the entire length of elongate portion 335A.

FIG. 3B shows a plot of the simulated magnetic flux density induced inside an extended magnetic core 330B having a central elongate portion 335B and a respective first and second extension 336B, 337B located at a respective first 333B and second end 334B of core 330B. For the simulations of FIG. 3B, the relative permeability, μ_{R}, of the material of core 330B was set to 100 and an external magnetic field of 1 Tesla was applied so that the results are normalized. The extended magnetic core 330B was constructed so as to have an elongate portion 335B having a length of 60 mm and a diameter of 10 mm, and with first and second extensions 336B, 337B each having diameters of 50 mm.

At the centre of the cylindrical magnetic core, the magnetic flux density—or B-field has a high value. The magnetic flux density maintains it's a high value along the entire length of elongate portion 335B.

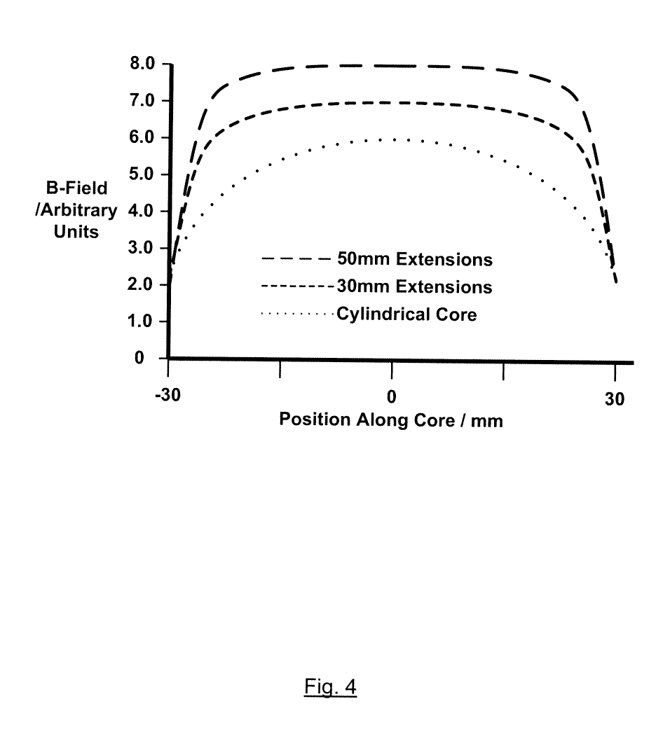

FIG. 4 shows a plot of the magnetic flux density induced inside the magnetic cores of FIG. 2, FIG. 3A and FIG. 3B plotted on the same axes. The three plots of FIG. 4 show the variation of the magnetic flux density inside the magnetic cores of cores of FIG. 2, FIG. 3A and FIG. 3B with distance along the axis of their respective central elongate portions 235, 335A, 335B. The units of the vertical axes of the plot of FIG. 4 are arbitrary.

It can be seen that the magnetic core of FIG. 3B, comprising flange portions 336B, 337B, each having diameters of 50 mm has the highest magnetic flux density of the three plots of FIG. 4. Moreover, the magnetic flux density inside the core 330B of FIG. 3B is substantially constant from just inside the first end 333B to just inside the second end 334B.

The magnetic flux density has an average value of 7.5 Units across the full length of core 330B. Moreover, the magnetic flux density stays above 7.0 Units to within a distances of 10 mm from respective first and second ends 333B, 334B, of core 330B.

By contrast the magnetic core of FIG. 2 has a lower magnetic flux density, having a peak value of 6 Units at the centre of the core, but falling off slowly to 2.5 Units at first end 233 and at second end 234. The average value of the magnetic flux density inside the core 230 of FIG. 2 is approximately 4.5 Units.

The magnetic flux density inside magnetic core of FIG. 3A falls somewhere between the field induced in magnetic core 230 of FIG. 2 and the field induced in magnetic core 330B of FIG. 3B. The average value of the magnetic flux density inside magnetic core 330A of FIG. 3A is 6.25 Units.

The increased average magnetic flux density inside magnetic core 330A of FIG. 3A and inside magnetic core 330B of FIG. 3B shows that both cores are suitable to provide an antenna having increased sensitivity compared with an antenna comprising a coil of wire, or a solenoid formed over a cylindrical core of the same magnetic material.

Thus, FIG. 4 illustrates the benefits of the present invention, wherein the addition of flange portions to an antenna comprising a coil of wire wound over a magnetic core provides an antenna having increased sensitivity compared with an antenna absent the extensions.

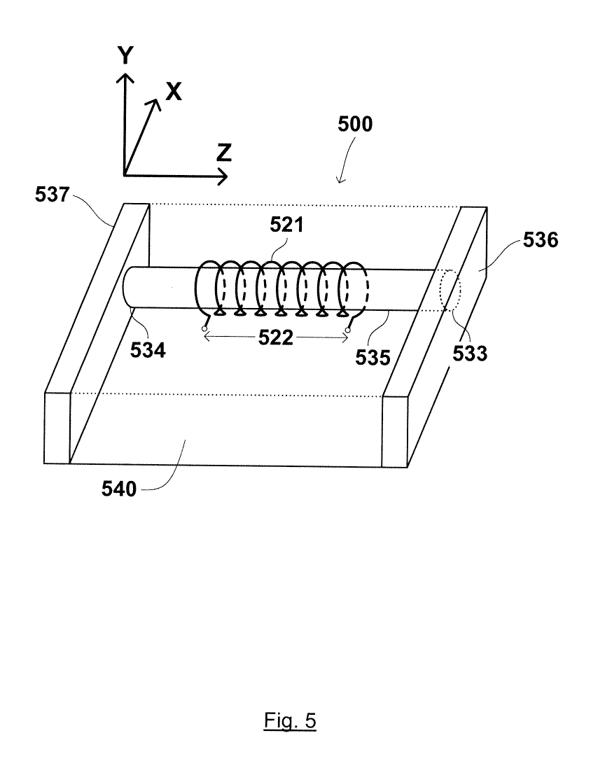

FIG. 5 shows an extended magnetic core antenna 500 housed inside a rectangular enclosure 540 according to a second embodiment of the present invention.

The extended magnetic core antenna 500 of FIG. 5 comprises a coil of wire 521 wound over a magnetic core 530 formed of a material having a relative magnetic permeability μ_{R} greater than unity, a material having a relative magnetic permeability of greater than 10 being particularly suitable. Coil 521 is formed of an electrically conductive wire having an electrically insulating coating. Coil 521 comprises input/output terminals 522. An output device (not shown), receiving output signals of antenna 500 may be connected to terminals 522. Alternatively, an input device (not shown), for feeding signals to antenna 500 may be connected to terminals 522. Magnetic core 530 comprises three separate portions: elongate portion 535, first flange portion 536 and second flange portion 537. Elongate portion 535 is substantially cylindrically shaped and is oriented so that it has a long dimension in a Z direction, and short dimensions in X and Y directions; orthogonal co-ordinate axes, X, Y and Z are shown in FIG. 5. First flange portion 536 is disposed at a first end 533 of elongate portion 535; and second flange portion 537 is disposed at a second end 534 of elongate portion 535. First flange portion 536 is rectangular in shape, and has a long dimension in the X direction, and a short dimension in the Z direction. First flange portion 536 covers an entire face of rectangular enclosure 540. Second flange portion 537 is also rectangular in shape and has a long dimension in the X direction, and a short dimension in the Z dimension. Second flange portion 537 also covers an opposing face of rectangular enclosure 540.

In the embodiment of the extended magnetic core antenna of FIG. 5, elongate portion 535 is cylindrically shaped. However, any elongate shape may alternatively be used to achieve the effects of the present invention.

Similarly, in the embodiment of the extended magnetic core antenna of FIG. 5, first flange portion 536 and second flange portion 537 are both directly connected to elongate portion 535. Nonetheless, the present invention may be embodied by an extended magnetic core antenna comprising an elongate portion and first and second flange portions where there is a gap between the elongate portion and the respective first and second flange portions.

The structure of the antenna 500 of the present invention depicted in FIG. 5 is particularly advantageous. For example, respective first and second flange portions 536, 537 may have a thickness in the Z direction which is very small. The limit is determined by availability of magnetic materials, however, a thickness of 2 mm is feasible. Embedding of flange portions 536, 537 inside enclosure is effective to provide an antenna which is mechanically robust. The use of large flange portions embedded in, or covering an entire face of rectangular enclosure 540 substantially increases the sensitivity of antenna 500 when compared with a rod antenna comprising only elongate portion 535 and absent flange portions 536, 537. Nonetheless, the additional volume occupied by flange portions, embedded inside the walls of enclosure 540 is minimal. Thus the antenna embodying the present invention depicted in FIG. 5 provides the advantage of improved sensitivity, without the drawback of increased size, and further without the drawback of increased resistive loss.

Embodiments of the present invention described herein refer specifically to antennas which are used for receiving electromagnetic signals, and refer specifically to antennas which detect the magnetic field component of an electromagnetic signal. Nonetheless, the antenna of the present invention is also suitable for use as a transmit antenna, wherein, during use, an input signal is fed to terminals of the antenna and the antenna excites the magnetic field component of an electromagnetic signal. For example, input signals from a transmitter circuit may be fed to terminals 122 of the antenna 100 of the present invention depicted in FIG. 1. The resulting currents which pass through coil 121 of antenna 100 excite the magnetic component of an electromagnetic signal.

The antenna of the present invention might also be used as a transmit and receive antenna, wherein, during a transmit mode of operation, an input signal is fed to input/output terminals of the antenna and the antenna excites the magnetic field component of an electromagnetic signal and during a receive mode of operation, a magnetic component of an electromagnetic signal is detected by the antenna and is output as a signal at input/output terminals of the antenna.

Other embodiments of the present invention include receivers comprising an antenna such as that of FIG. 1 connected to a radio receiver circuit comprising oscillators, mixers, de-modulators, signal processors and other electronic circuitry as would be known by a person skilled in the art. A radio receiver might alternatively be incorporated inside housing 540 of the antenna of the present invention depicted in FIG. 5.

Still further embodiments of the present invention include transmitters comprising an antenna such as that of FIG. 1 connected to a radio transmitter comprising oscillators, mixers, de-modulators, signal processors and other electronic circuitry as would be known by a person skilled in the art.

Embodiments of the present invention are particular suited to underwater and/or seawater environments where low frequency electromagnetic signaling is a means of communications and data transfer.

Embodiments of the present invention are also particular suited to through-the-earth communications where low frequency electromagnetic signaling is a means of communications and data transfer.

The extended magnetic core antenna of present invention can be deployed in systems for communications through the earth. Similarly, the extended magnetic core antenna of the present invention may be deployed in systems for communications through water.

Thus, the present invention, embodied in the various figures and descriptions described herein provides an antenna for sensing a magnetic field component of an electromagnetic signal having an extended core of a high magnetic permeability material which provides increased sensitivity of the antenna compared with an antenna having a ferrite rod core.

Similarly, the present invention, embodied in the various figures and descriptions described herein provides an antenna for sensing a magnetic field component of an electromagnetic signal having an extended core where the extended core does not result in a substantial increase in the volume occupied by the antenna compared with an antenna having a ferrite rod core.

The descriptions of the specific embodiments herein are made by way of example only and not for the purposes of limitation. It will be obvious to a person skilled in the art that in order to achieve some or most of the advantages of the present invention, practical implementations may not necessarily be exactly as exemplified and can include variations within the scope of the present invention.

What is claimed is:

1. An extended magnetic core antenna for coupling to a magnetic field component of an electromagnetic signal,
said antenna comprising a coil formed over an extended core of a material having a relative magnetic permeability (μ_{R}) greater than unity;
said extended core comprising an elongate portion having a long dimension along a first (Z) axis and short dimensions in a (X, Y) plane perpendicular to said first axis, and comprising first and second ends at opposite extremities of said long dimension; said extended core further comprising at least one flange portion disposed at one of said first and said second ends, and having at least one larger dimension than said elongate section in said (X, Y) perpendicular plane,
wherein said extended core has an increased effective magnetic permeability compared with a core absent said at least one flange portion.

2. An extended magnetic core antenna according to claim 1, wherein said extended core provides an antenna having an increased sensitivity for receiving said electromagnetic signal compared with an antenna comprising a core absent said at least one flange portion.

3. An extended magnetic core antenna according to claim 1, wherein said extended core provides an antenna having an increased efficiency for transmitting said electromagnetic signal compared with an antenna comprising a core absent said at least one flange portion.

4. An extended magnetic core antenna according to claim 1, wherein said coil is wound around said elongate portion of said extended core.

5. An extended magnetic core antenna according to claim 1, wherein said coil further comprises a pair of terminals, said extended core providing an increased induced voltage at said pair of terminals compared with an antenna comprising a core absent said at least one flange portion.

6. An extended magnetic core antenna according to claim 1, wherein said antenna is a transmit and receive antenna.

7. An extended magnetic core antenna according to claim 1, wherein said at least one flange portion is in contact with said elongate section at one of said first and said second ends.

8. An extended magnetic core antenna according to claim 1, wherein said long (Z) dimension of said elongate portion of said core is at least five times greater than each said short (X, Y) dimension thereof.

9. An extended magnetic core antenna according to claim 1, wherein said coil is formed of electrically conductive wire having an electrically insulating covering.

10. An extended magnetic core antenna according to claim 1, wherein the material of said extended core is ferrite.

11. An extended magnetic core antenna according to claim 1, wherein the material of said extended core has a relative magnetic permeability (μ_{R}) greater than 10.

12. An extended magnetic core antenna according to claim 1, wherein said flange portion extends away from said elongate portion in at least one direction in said (X, Y) perpendicular plane.

13. An extended magnetic core antenna according to claim 1, comprising first and second flange portions respectively disposed at said first and second ends of said elongate portion of said extended core.

14. An extended magnetic core antenna according to claim 1, wherein a cross section of said elongate section of said extended core in said perpendicular (X, Y) plane is circular.

15. An extended magnetic core antenna according to claim 1, wherein said electromagnetic signal has a frequency in the range from 1 Hz to 100 MHz.

16. An extended magnetic core antenna according to claim 1, further comprising a housing wherein said at least one flange portion is flush with a wall of said housing.

17. An extended magnetic core antenna according to claim 16, wherein said at least one flange portion is formed inside a wall of said housing.

18. A receiver for receiving an electromagnetic signal comprising an extended magnetic core antenna according to claim 1.

19. A system for communications through water comprising an extended magnetic core antenna according to claim 1.

20. A system for communications through the earth comprising an extended magnetic core antenna according to claim 1.
